(19) United States
(12) Patent Application Publication
(10) Pub. No.: US 2025/0243742 A1
(43) Pub. Date: Jul. 31, 2025

(54) Predicting Reservoir Properties Based on Seismic Inversion

(71) Applicant: Saudi Arabian Oil Company, Dhahran (SA)

(72) Inventor: Aun Al Ghaithi, Dhahran (SA)

(21) Appl. No.: 18/425,045

(22) Filed: Jan. 29, 2024

(51) Int. Cl. E21B 44/00; G01V 1/50

(52) U.S. Cl. CPC E21B 44/00; G01V 1/50; E21B 2200/20; E21B 2200/22

(57) ABSTRACT

Systems and methods for predicting reservoir properties in a subsurface formation include accessing, from a data store, seismic inversion data and well log data for the subsurface formation. A training dataset is generated including data extracted from the seismic inversion data based on locations of wells in the subsurface formation and the well log data from the wells. The training dataset includes, for a set of wells in the subsurface, seismic inversion data with corresponding labeled data representing total porosity values and electro-facies values. A neural network is trained based on the training dataset, and porosity values for the reservoir are predicted based on the seismic inversion data and the trained neural network.

### TECHNICAL FIELD

The present disclosure generally relates to geological modeling of a subsurface formation.

### BACKGROUND

In geology, sedimentary facies are bodies of sediment that are recognizably distinct from adjacent sediments that resulted from different depositional environments. Generally, geologists distinguish facies by aspects of the rock or sediment being studied. Seismic facies are groups of seismic reflections whose parameters (such as amplitude, continuity, reflection geometry, and frequency) differ from those of adjacent groups. Seismic facies analysis, a subdivision of seismic stratigraphy, plays an important role in hydrocarbon exploration and is one key step in the interpretation of seismic data for reservoir characterization. The seismic facies in a given geological area can provide useful information, particularly about the types of sedimentary deposits and the anticipated lithology.

In reflection seismology, geologists and geophysicists perform seismic surveys to map and interpret sedimentary facies and other geologic features for applications such as, for example, identification of potential petroleum reservoirs. Seismic surveys are conducted by using a controlled seismic source (for example, Vibroseis or dynamite) to create a seismic wave. The seismic source is typically located at ground surface. The seismic wave travels into the ground, is reflected by subsurface formations, and returns to the surface where it is recorded by sensors called geophones. The geologists and geophysicists analyze the time it takes for the seismic waves to reflect off subsurface formations and return to the surface to map sedimentary facies and other geologic features. This analysis can also incorporate data from sources such as, for example, borehole logging, gravity surveys, and magnetic surveys.

### SUMMARY

This disclosure describes systems and methods for predicting reservoir properties based on seismic inversion data of a subsurface formation. A data processing system (e.g., a computer or control system) accesses seismic inversion data and well log data from a data store. The data processing system generates a training dataset to train a neural network. The training dataset includes data extracted from the seismic inversion data at well location in the subsurface formation. The training dataset also includes corresponding well logs from the wells. The data processing system trains the neural network based on the training dataset. The data processing system predicts reservoir properties, such as three-dimensional (3D) distributions of porosity and electro-facies, based on the seismic inversion data and the trained neural network.

Implementations of the systems and methods of this disclosure can provide various technical benefits. The data processing system predicts reservoir properties without including low frequency well log models as input into the neural network resulting in a more accurate model without averaging or interpolation effects from the well log models. The data processing system trains the neural network with bandpass seismic inversion data as input to the neural network enabling the data processing system to predict reservoir properties without including low frequency well log models as input into the neural network. Bandpass seismic inversion data includes reservoir quality information between drilled wells in the subsurface formation.

The predicted reservoir properties can guide the placement of wells in the subsurface formation. For example, the data processing system can determine locations to drill wells based on the predicted reservoir properties. The data processing system can generate commands to control remote drilling equipment based on the predicted reservoir properties and the determined locations to drill wells. The predicted reservoir properties can also be useful for characterizing a reservoir (e.g., during reservoir modeling) and for quantifying uncertainty in a reservoir modeling process.

The details of one or more embodiments of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is a schematic view of a seismic survey being performed to map subsurface features such as facies and faults.

FIG. 2 is a flowchart of a method for predicting reservoir properties.

FIGS. 3A-3B are cross-sections of a subsurface formation showing absolute acoustic impedance and bandpass acoustic impedance derived from seismic data.

FIG. 4 is a composite plot showing acoustic impedance, porosity, and electro-facies data at a well location.

FIG. 5 is a composite plot showing input seismic inversion data, true porosity and porosity predicted by a neural network.

FIG. 6 is a composite plot showing input seismic inversion data, true porosity, measured electro-facies and predicted electro-facies.

FIG. 7 is a flow chart of another method for predicting reservoir properties.

FIG. 8 illustrates hydrocarbon production operations that include field operations and computational operations.

FIG. 9 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

This specification describes systems and methods for predicting reservoir properties based on seismic inversion data from a subsurface formation. A data processing system (e.g., a computer or control system) accesses seismic inversion data and well log data from a data store. Seismic inversion data includes, for example, absolute and bandpass acoustic impedance of the subsurface formation. The data processing system generates a training dataset to train a neural network. The training dataset includes data extracted from the seismic inversion data at well locations in the subsurface formation. The training dataset also includes labeled data derived from well logs (e.g., porosity data and electro-facies data) from the wells. The data processing system trains the neural network based on the training dataset. The data processing system predicts reservoir properties, such as three-dimensional (3D) distributions of porosity and electro-facies, based on the seismic inversion data and the trained neural network.

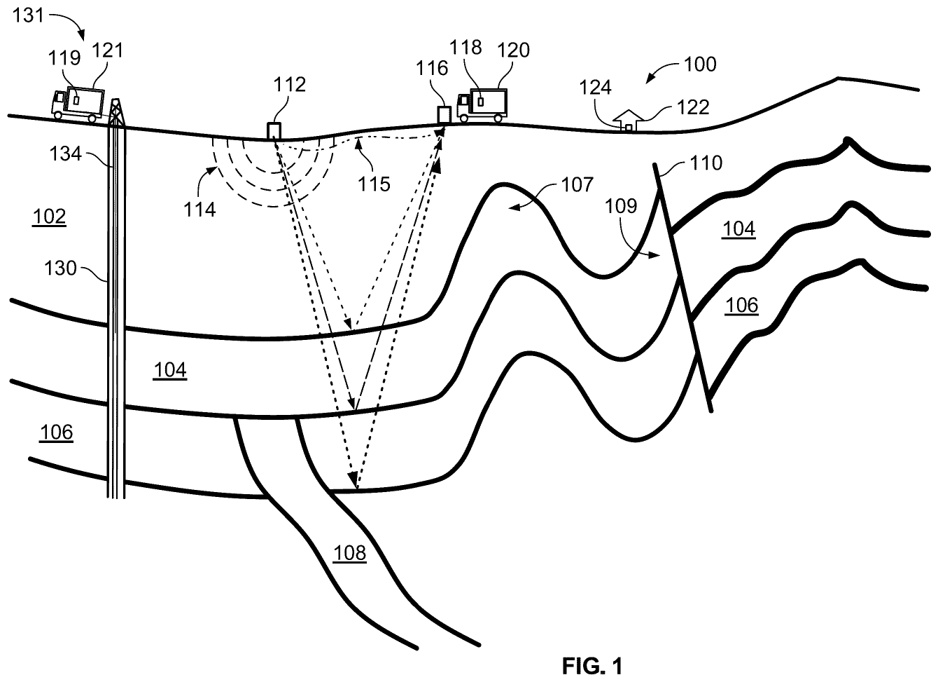

FIG. 1 is a schematic view of a seismic survey being performed to map subsurface features such as facies and faults in a subsurface formation 100. The data generated by the seismic survey is useful for modeling the subsurface formation and predicting reservoir properties of hydrocarbon reservoirs. The subsurface formation 100 includes a layer of impermeable cap rocks 102 at the surface. Facies underlying the impermeable cap rocks 102 include a sandstone layer 104, a limestone layer 106, and a sand layer 108. A fault line 110 extends across the sandstone layer 104 and the limestone layer 106.

A seismic source 112 (for example, a seismic vibrator or an explosion) generates seismic waves 114 that propagate in the earth. The velocity of these seismic waves depends on properties such as, for example, density, porosity, and fluid content of the medium through which the seismic waves are traveling. Different geologic bodies or layers in the earth are distinguishable because the layers have different properties and, thus, different characteristic seismic velocities. For example, in the subsurface formation 100, the velocity of seismic waves traveling through the subsurface formation 100 will be different in the sandstone layer 104, the limestone layer 106, and the sand layer 108. As the seismic waves 114 contact interfaces between geologic bodies or layers that have different velocities, the interface reflects some of the energy of the seismic wave and refracts part of the energy of the seismic wave. Such interfaces are sometimes referred to as horizons.

The seismic waves 114 are received by a sensor or sensors 116. Although illustrated as a single component in FIG. 1, the sensor or sensors 116 are typically a line or an array of sensors 116 that generate an output signal in response to received seismic waves including waves reflected by the horizons in the subsurface formation 100. The sensors 116 can be geophone-receivers that produce electrical output signals transmitted as input data, for example, to a computer 118 on a seismic control truck 120. Based on the input data, the computer 118 may generate a seismic data output such as, for example, a seismic two-way response time plot.

A control center 122 can be operatively coupled to the seismic control truck 120 and other data acquisition and wellsite systems. The control center 122 may have computer facilities for receiving, storing, processing, and/or analyzing data from the seismic control truck 120 and other data acquisition and wellsite systems. For example, computer systems 124 in the control center 122 can be configured to analyze, model, control, optimize, or perform management tasks of field operations associated with development and production of resources such as oil and gas from the subsurface formation 100. Alternatively, the computer systems 124 can be located in a different location than the control center 122. Some computer systems are provided with functionality for manipulating and analyzing the data, such as performing seismic interpretation or borehole resistivity image log interpretation to identify geological surfaces in the subsurface formation or performing simulation, planning, and optimization of production operations of the wellsite systems.

Petrophysical and electro-facies data can be collected for wells in the subsurface formation (e.g., wellbore 130) through a wireline logging operation 131. A logging tool 132 is lowered down the wellbore 130 on a wireline 134. The logging tool 132 is string of one or more instruments with sensors operable to measure petrophysical properties of the subsurface formation 100. For example, logging tools can include resistivity logs, borehole image logs, porosity logs, density logs, or sonic logs. Resistivity logs measure the subsurface electrical resistivity, which is the ability to impede the flow of electric current. These logs can help differentiate between formations filled with salty waters (good conductors of electricity) and those filled with hydrocarbons (poor conductors of electricity). Porosity logs measure the fraction or percentage of pore volume in a volume of rock using acoustic or nuclear technology. Acoustic logs measure characteristics of sound waves propagated through the well-bore environment. Nuclear logs utilize nuclear reactions that take place in the downhole logging instrument or in the formation. Density logs measure the bulk density of a formation by bombarding it with a radioactive source and measuring the resulting gamma ray count after the effects of Compton scattering and photoelectric absorption. Sonic logs provide a formation interval transit time, which typically a function of lithology and rock texture but particularly porosity. The logging tool includes a piezoelectric transmitter and receiver and the time taken for the sound wave to travel the fixed distance between the two is recorded as an interval transit time.

As the logging tool 132 travels downhole, measurements of formations properties are recorded to generate a well log. In the illustrated operation, the data are recorded at the control truck 121 in real-time by, for example, a control system 119. Real-time data are recorded directly against measured cable depth. In some well-logging operations, the data is recorded at the logging tool 132 and downloaded later. In this approach, the downhole data and depth data are both recorded against time The two data sets are then merged using the common time base to create an instrument response versus depth log.

In the wireline operation 131, the well logging is performed on a wellbore 130 that has already been drilled. In some operations, well logging is performed in the form of logging while drilling techniques. In these techniques, the sensors are integrated into the drill string and the measurements are made in real-time, during drilled rather using sensors lowered into a well after drilling.

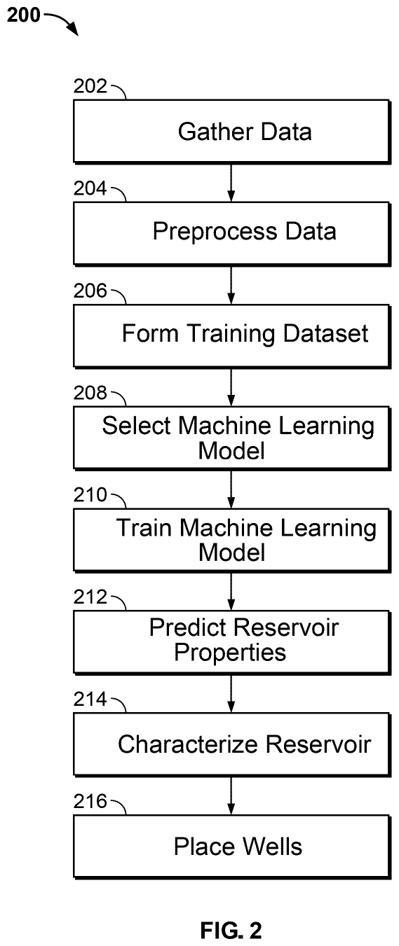

FIG. 2 is a flow chart of an example method 200 for predicting reservoir properties based on a machine learning model. The method 200 can be implemented, for example, on a data processing system such as a computer or a control system.

The data processing system gathers exploratory data (step 202) by, for example, accessing data from a data store or collecting and recording data during an exploration operation (e.g., seismic survey or wireline operation). The exploratory data includes seismic inversion data including absolute and bandpass seismic inversion volumes. Absolute seismic inversion data includes frequencies near 0 Hz, which can be generated by combining relative seismic inversion data with low frequency models derived from well logs. Bandpass seismic inversion data includes seismic inversion data that has been filtered to remove low frequency and high frequency content. The seismic inversion data can include post-stack and/or pre-stack seismic data. The seismic inversion data can also include absolute and bandpass velocity ratio data.

The exploratory data also includes petrophysical data (e.g., porosity) and electro-facies data derived from well log data for wells in the subsurface formation. Electro-facies data include unique combinations of well log responses that characterize a lithologic unit and permit a stratigraphic interval to be correlated with or distinguished from other stratigraphic intervals. The depth values of the seismic inversion data and the well log data can be correlated by, for example, using a time-depth relationship.

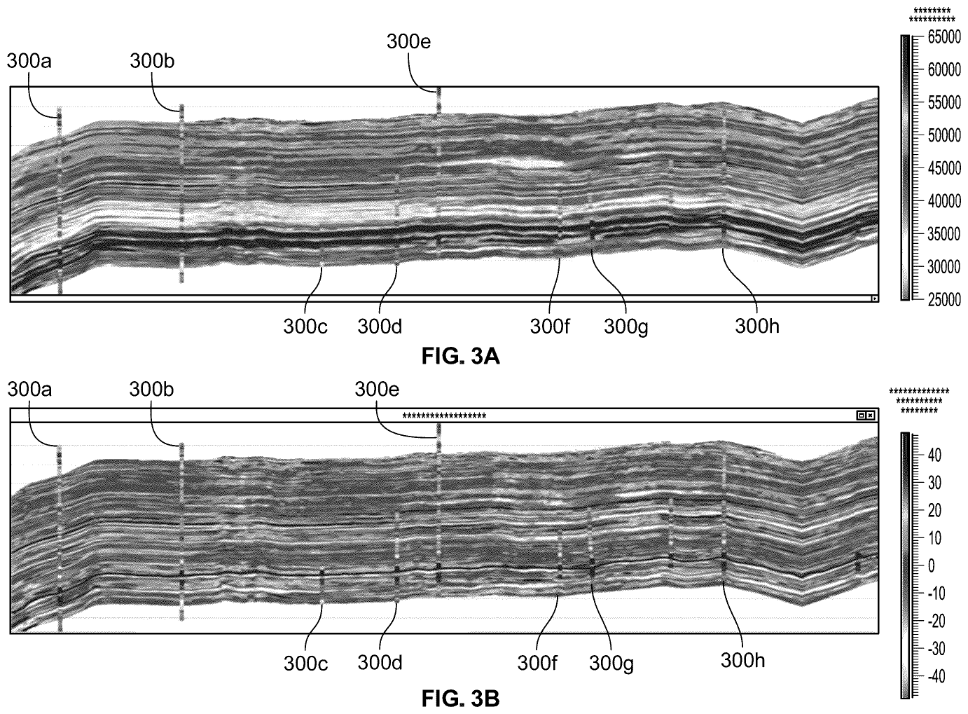

Turning briefly to FIGS. 3A-3B, example cross-sections of a subsurface formation show seismic inversion data. FIG. 3A shows absolute acoustic impedance. FIG. 3B shows bandpass acoustic impedance. Well penetrations 300a-h are seen in both cross-sections.

Turning back to FIG. 2, the data processing system performs data preprocessing on the exploratory data (step 204). Data preprocessing can include removing missing values from the datasets and normalizing the data. Normalizing the data can include transforming the data to have values within the range of 0 to 1. For example, the data processing system can normalize the data by subtracting the minimum value of the data from each sample and dividing by the difference between the maximum and minimum values in the data. The data processing system can also pad the data with zeros to adjust the length of the data samples to have a defined sample length.

The data processing system forms a training dataset based on the preprocessed data (step 206). Forming the training dataset can include feature engineering (step 206). For example, feature engineering includes selecting and/or transforming seismic inversion data to be used as input to the machine learning model. For example, the data processing system selects features from seismic inversion data including the absolute and bandpass impedance traces, and the absolute and bandpass velocity traces if the pre-stack seismic inversion data is available. The data processing system can use criteria such as a correlation coefficient to select the features to use for training the model.

The data processing system forms the training dataset based on the engineered features. For example, the data processing system extracts seismic inversion data from the exploratory data based on the engineered features at locations corresponding to wells in the subsurface formation (e.g., at well penetrations 300a-h). The data processing system generates labeled data from well logs (e.g., porosity well logs) corresponding to the locations where seismic inversion data was extracted. The training dataset includes seismic inversion data as input to the machine learning model with corresponding labeled well log data.

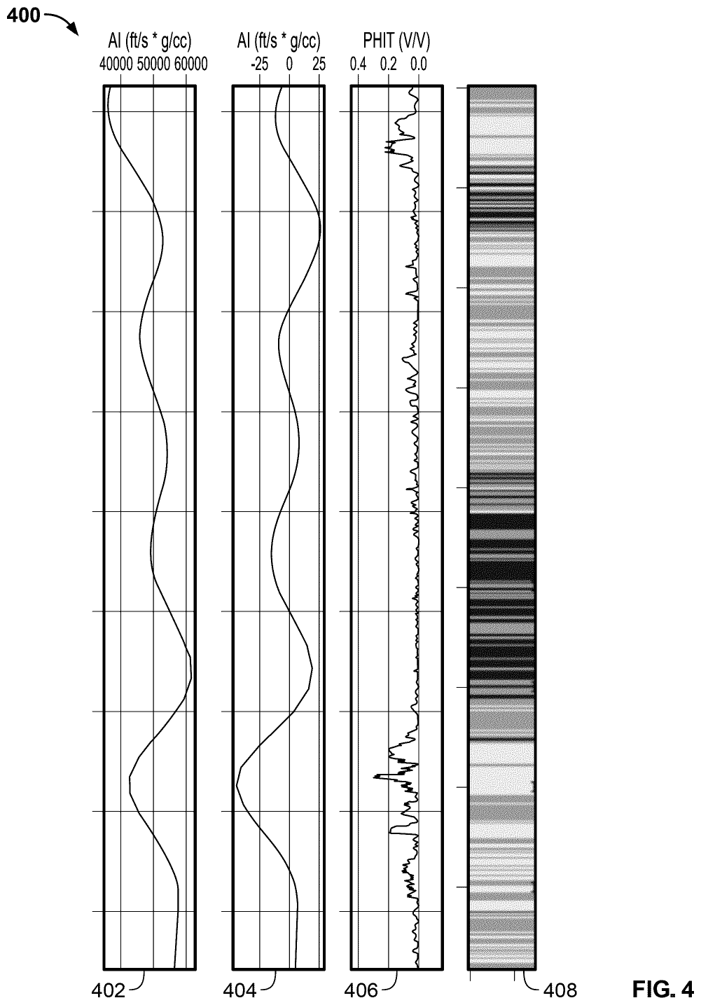

FIG. 4 is a composite plot 400 of data corresponding to a well that can be used as training data for a machine learning model. Plot 402 shows a trace of absolute acoustic impedance extracted from a seismic inversion volume at the well location. Plot 404 shows bandpass acoustic impedance extracted from a seismic inversion volume at the well location. Plot 406 shows total porosity derived from a well log. Plot 408 shows electro-facies derived from a well log. The absolute acoustic impedance and bandpass acoustic impedance in plots 402, 404 can be used as input to the machine learning model. Total porosity and electro-facies from plots 406 and 408 can be used as labeled data for training the model.

Referring back to FIG. 2, the data processing system selects a machine learning model (step 208). For example, the data processing system selects a neural network. In some implementations, the data processing system selects a one-dimensional convolutional neural network with a recurrent layer. While neural networks such as convolutional neural networks can perform better than other machine learning models on seismic data that includes noise and variability, other machine learning models (e.g., linear regression models, decision trees, or K-Nearest Neighbor models) can also be used in the method 200.

The data processing system can tune hyperparameters of the model to select an architecture for the model. Hyperparameters include external configuration parameters that affect model performance. Examples of hyperparameters include learning rate, number of hidden layers, number of neurons in each layer, type of each layer, the optimizer used, etc. The data processing system can tune the hyperparameters by selecting values for target hyperparameters, training the model based on the training dataset, assessing model performance, and selecting the set of hyperparameters that generates a trained model that achieves a desired value of a performance metric. A performance metric can be, for example, a root mean squared error, a correlation coefficient, or a coefficient of determination. In some implementations, the data processing system tunes the hyperparameters based on a Bayesian optimization, a grid search, or a random search.

In an example implementation, the data processing system selects a convolutional neural network having a 1D convolutional layer with 20 filters and a kernel size of 60, a gated recurrent layer with 100 neurons, a dropout layer with 20% dropout, a repetition of a gated recurrent layer with 100 neurons, a dropout layer with 20% dropout, a dense layer with 100 neurons, and a final dropout layer with 20% dropout. The neural network was iterated for 300 epochs.

The data processing system trains the selected machine learning model based on the training dataset (step 210). During training, the data processing system adjusts values of weights of the machine learning model to create a mapping from seismic inversion input data to petrophysical property and/or electro-facies output data.

The data processing system splits the training dataset into subsets to form a training set, a validation set and/or a test set. For example, the data processing system shuffles the training dataset and selects 80% of the data for training and 20% of the data for blind testing. For example, for 100 wells in the subsurface formation, data from 80 wells are used for training and data from the remaining 20 wells are used as blind testing data.

The data processing system evaluates performance of the machine learning model during the training process using the validation set. After training the machine learning model using the training and validation sets, the data processing system evaluates the performance of the machine learning model based on the blind test set.

In some implementations, the data processing system trains the machine learning model using cross validation techniques. Cross validation includes training and evaluating the machine learning model on multiple different splits of the training data. Cross validation can help avoid overfitting of the machine learning model to the training data. The data processing system can perform cross validation using, for example, k-folds or leave-one-out methods.

The data processing system predicts reservoir properties based on the trained machine learning model (step 212). The machine learning model takes as input the seismic inversion data and outputs the reservoir properties. The machine learning model can predict reservoir properties at locations without a well drilled in the subsurface formation.

In some implementations, the data processing system provides three-dimensional (3D) seismic inversion volumes as input to the machine learning model and receives 3D distributions of properties as outputs from the machine learning model. For example, the machine learning model can output 3D distributions of porosity or 3D distributions of electro-facies.

The data processing system can characterize the reservoir based on the predicted reservoir properties (step 214). For example, the data processing system can produce reservoir quality volumes (e.g., geobodies) that contain information on facies, porosities and saturation within the reservoir. The reservoir quality volumes indicate locations within the reservoir that are likely to contain hydrocarbons.

In some implementations, the data processing system generates visual representations of the predicted reservoir properties. The visual representations are useful for identifying features in the reservoir and validating output from the data processing system. For example, the data processing system can generate one-dimensional traces of the predicted reservoir properties. In another example, the data processing system can generate 3D visual representations of the reservoir based on the 3D distributions of predicted reservoir properties. The 3D visual representations are able to be rotated, panned, zoomed, and/or sliced to visually inspect the distribution of properties in the reservoir.

The data processing system can determine locations to place wells in the subsurface formation based at least in part on the predicted reservoir properties (step 216). For example, the data processing system can determine a location to place a well based on values of porosity or electro-facies indicating that the location is likely to contain hydrocarbons. The data processing system can generate control commands to control remote drilling equipment to drill the wells at the determined locations based at least in part on the predicted reservoir properties.

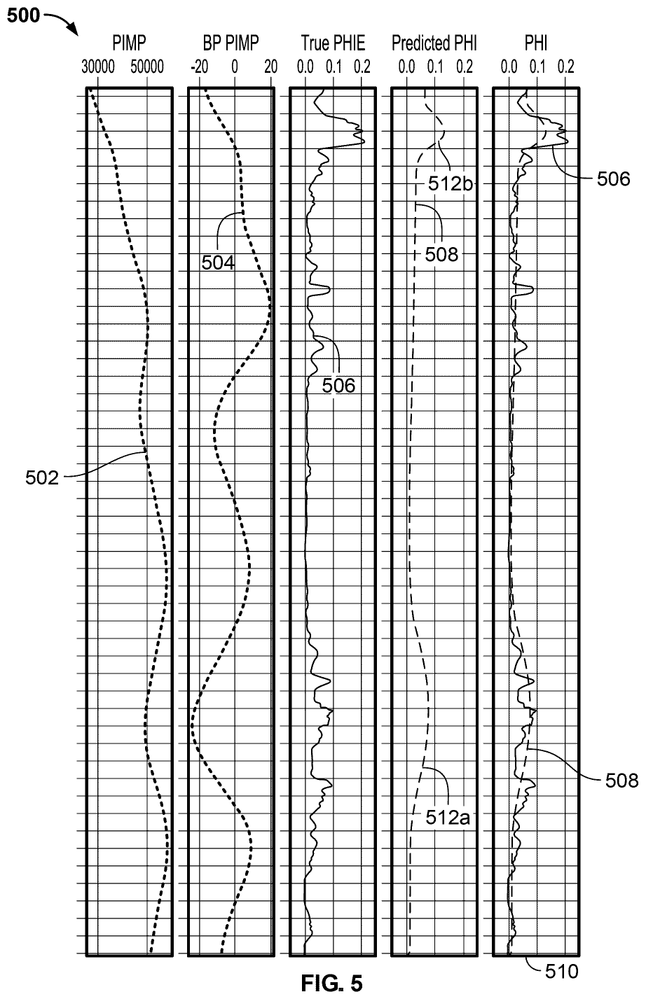

FIG. 5 is a composite plot 500 showing the prediction performance of an example machine learning model on a blind test well outputting petrophysical logs. Absolute seismic inversion data 502 and bandpass seismic inversion data 504 are the inputs to the machine learning model. The true porosity 506 is obtained from well log data. The predicted porosity 508 is an output of the machine learning model. The machine learning model predicted porosity 508 captures the trend of the true porosity 506 as shown in the subplot 510. The predicted porosity 506 captures the high porosity lobes 512a-b which aids in characterizing the most profitable hydrocarbon target zones.

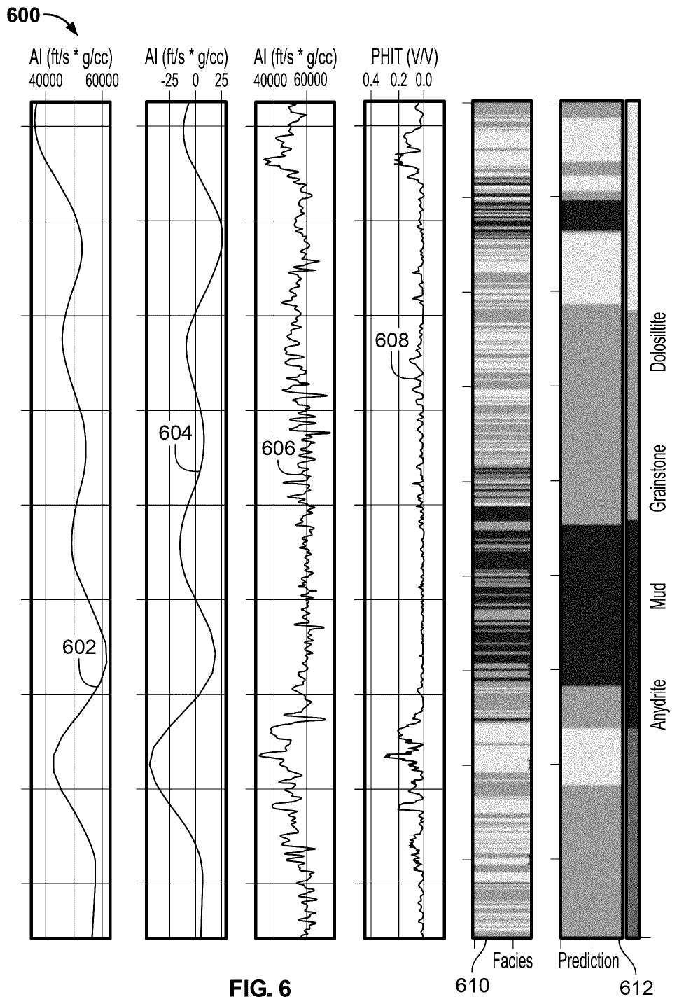

FIG. 6 is a composite plot 600 showing the machine learning prediction on a blind test well outputting facies prediction. Absolute seismic inversion data 602 and bandpass seismic inversion data 604 are inputs into the machine learning model. Acoustic impedance 606, porosity 608, and electro-facies data 610 are derived from well logs. In some implementations, the low frequency content in the absolute seismic data is constructed from well logs. Predicted electro-facies 612 are output from the machine learning model. The machine learning model predicted the overall trend of the electro-facies along the depth of the well. The good quality facies (e.g., grain stone) from the bad quality facies (e.g., mud and anhydrite) within the seismic resolution. Distinguishing the good quality facies identifies reservoir zones that may hold hydrocarbons.

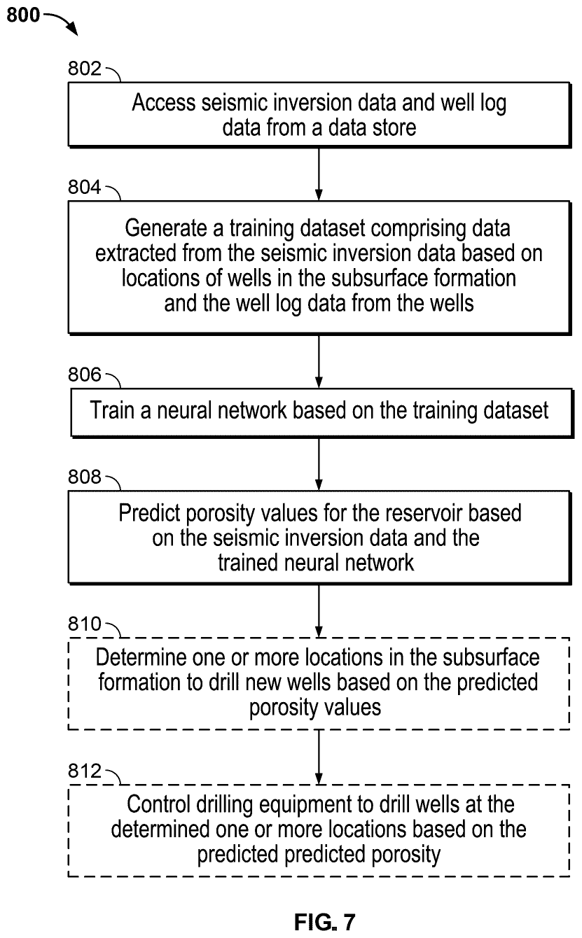

FIG. 7 is another method 800 for predicting reservoir properties in a subsurface formation. A data processing system accesses seismic inversion data and well log data from a data store (step 802). The data store can be local to the data processing system or a remote data store (e.g., a cloud-based or network data store).

The data processing system generates a training dataset including data extracted from the seismic inversion data based on locations of wells in the subsurface formation and the well log data from the wells (step 804). Generating the training data set can include removing missing values from the training dataset; normalizing the training dataset; and zero-padding the training dataset based on a specified sample length.

The data processing system trains a neural network based on the training data set (step 806). The training can include splitting the training data into subsets for training, validation, and blind testing. The data processing system can tune hyperparameters of the neural network based on a computed mean-squared error between the well log data and the data generated by the neural network.

The data processing system predicts porosity values for the reservoir based on the seismic inversion data and the trained neural network (step 808). The neural network can take as input 3D seismic inversion volumes and output 3D distributions of predicted reservoir properties.

The data processing system can determine one or more locations in the subsurface formation to drill new wells based on the predicted porosity values (step 810). For example, high porosity values and/or good quality seismic facies can indicate good locations to drill new wells.

The data processing system can control drilling equipment to drill wells at the determined one or more locations based on the predicted porosity values (step 812). For example, the data processing system can generate commands to control remote drilling equipment based on the predicted reservoir properties.

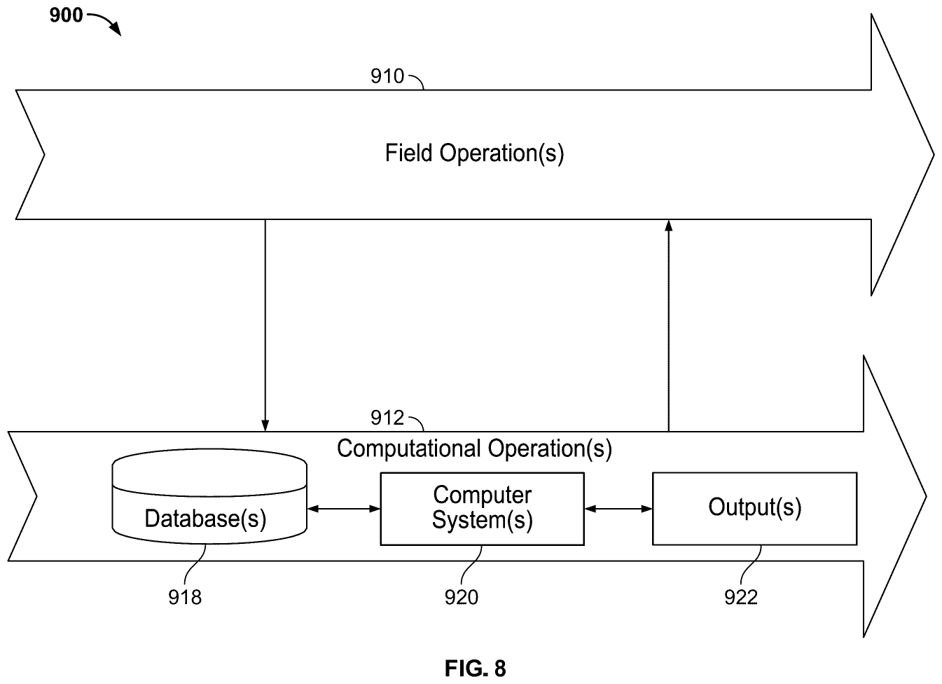

FIG. 8 illustrates hydrocarbon production operations 900 that include both one or more field operations 910 and one or more computational operations 912, which exchange information and control exploration for the production of hydrocarbons. In some implementations, outputs of techniques of the present disclosure (e.g., the method 300) can be performed before, during, or in combination with the hydrocarbon production operations 900, specifically, for example, either as field operations 910 or computational operations 912, or both. For example, the method 300 collects data during field operations, processes the data in computational operations, and can determine locations to perform additional field operations.

Examples of field operations 910 include forming/drilling a wellbore, hydraulic fracturing, producing through the wellbore, injecting fluids (such as water) through the wellbore, to name a few. In some implementations, methods of the present disclosure can trigger or control the field operations 910. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 910 and responsively triggering the field operations 910 including, for example, generating plans and signals that provide feedback to and control physical components of the field operations 910. Alternatively, or in addition, the field operations 910 can trigger the methods of the present disclosure. For example, implementing physical components (including, for example, hardware, such as sensors) deployed in the field operations 910 can generate plans and signals that can be provided as input or feedback (or both) to the methods of the present disclosure.

Examples of computational operations 912 include one or more computer systems 920 that include one or more processors and computer-readable media (e.g., non-transitory computer-readable media) operatively coupled to the one or more processors to execute computer operations to perform the methods of the present disclosure. The computational operations 912 can be implemented using one or more databases 918, which store data received from the field operations 910 and/or generated internally within the computational operations 912 (e.g., by implementing the methods of the present disclosure) or both. For example, the one or more computer systems 920 process inputs from the field operations 910 to assess conditions in the physical world, the outputs of which are stored in the databases 918. For example, seismic sensors of the field operations 910 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 912 where they are stored in the databases 918 and analyzed by the one or more computer systems 920.

In some implementations, one or more outputs 922 generated by the one or more computer systems 920 can be provided as feedback/input to the field operations 910 (either as direct input or stored in the databases 918). The field operations 910 can use the feedback/input to control physical components used to perform the field operations 910 in the real world.

For example, the computational operations 912 can process the seismic data to generate three-dimensional (3D) maps of the subsurface formation. The computational operations 912 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 912 to process new information about the formation and control the drilling to adjust to the observed conditions in real-time.

The one or more computer systems 920 can update the 3D maps of the subsurface formation as information from one exploration well is received and the computational operations 912 can adjust the location of the next exploration well based on the updated 3D maps. Similarly, the data received from production operations can be used by the computational operations 912 to control components of the production operations. For example, production well and pipeline data can be analyzed to predict slugging in pipelines leading to a refinery and the computational operations 912 can control machine operated valves upstream of the refinery to reduce the likelihood of plant disruptions that run the risk of taking the plant offline.

In some implementations of the computational operations 912, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

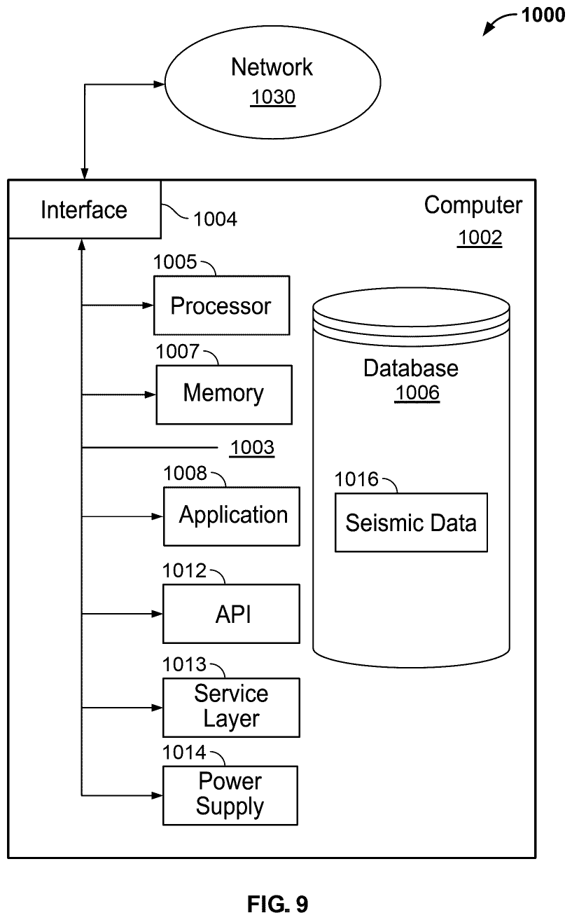

FIG. 9 is a block diagram of an example computer system 1000 used to provide computational functionalities associated with described algorithms, methods, functions, processes, flows, and procedures described in the present disclosure, according to some implementations of the present disclosure. The illustrated computer 1002 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1002 can include input devices such as keypads, keyboards, and touch screens that can accept user information. Also, the computer 1002 can include output devices that can convey information associated with the operation of the computer 1002. The information can include digital data, visual data, audio information, or a combination of information. The information can be presented in a graphical user interface (UI) (or GUI).

The computer 1002 can serve in a role as a client, a network component, a server, a database, a persistency, or components of a computer system for performing the subject matter described in the present disclosure. The illustrated computer 1002 is communicably coupled with a network 1030. In some implementations, one or more components of the computer 1002 can be configured to operate within different environments, including cloud-computing-based environments, local environments, global environments, and combinations of environments.

At a high level, the computer 1002 is an electronic computing device operable to receive, transmit, process, store, and manage data and information associated with the described subject matter. According to some implementations, the computer 1002 can also include, or be communicably coupled with, an application server, an email server, a web server, a caching server, a streaming data server, or a combination of servers.

The computer 1002 can receive requests over network 1030 from a client application (for example, executing on another computer 1002). The computer 1002 can respond to the received requests by processing the received requests using software applications. Requests can also be sent to the computer 1002 from internal users (for example, from a command console), external (or third) parties, automated applications, entities, individuals, systems, and computers.

Each of the components of the computer 1002 can communicate using a system bus 1003. In some implementations, any or all of the components of the computer 1002, including hardware or software components, can interface with each other or the interface 1004 (or a combination of both), over the system bus 1003. Interfaces can use an application programming interface (API) 1012, a service layer 1013, or a combination of the API 1012 and service layer 1013. The API 1012 can include specifications for routines, data structures, and object classes. The API 1012 can be either computer-language independent or dependent. The API 1012 can refer to a complete interface, a single function, or a set of APIs.

The service layer 1013 can provide software services to the computer 1002 and other components (whether illustrated or not) that are communicably coupled to the computer 1002. The functionality of the computer 1002 can be accessible for all service consumers using this service layer. Software services, such as those provided by the service layer 1013, can provide reusable, defined functionalities through a defined interface. For example, the interface can be software written in JAVA, C++, or a language providing data in extensible markup language (XML) format. While illustrated as an integrated component of the computer 1002, in alternative implementations, the API 1012 or the service layer 1013 can be stand-alone components in relation to other components of the computer 1002 and other components communicably coupled to the computer 1002. Moreover, any or all parts of the API 1012 or the service layer 1013 can be implemented as child or sub-modules of another software module, enterprise application, or hardware module without departing from the scope of the present disclosure.

The computer 1002 includes an interface 1004. Although illustrated as a single interface 1004 in FIG. 9, two or more interfaces 1004 can be used according to particular needs, desires, or particular implementations of the computer 1002 and the described functionality. The interface 1004 can be used by the computer 1002 for communicating with other systems that are connected to the network 1030 (whether illustrated or not) in a distributed environment. Generally, the interface 1004 can include, or be implemented using, logic encoded in software or hardware (or a combination of software and hardware) operable to communicate with the network 1030. More specifically, the interface 1004 can include software supporting one or more communication protocols associated with communications. As such, the network 1030 or the interface's hardware can be operable to communicate physical signals within and outside of the illustrated computer 1002.

The computer 1002 includes a processor 1005. Although illustrated as a single processor 1005 in FIG. 9, two or more processors 1005 can be used according to particular needs, desires, or particular implementations of the computer 1002 and the described functionality. Generally, the processor 1005 can execute instructions and can manipulate data to perform the operations of the computer 1002, including operations using algorithms, methods, functions, processes, flows, and procedures as described in the present disclosure.

The computer 1002 also includes a database 1006 that can hold data for the computer 1002 and other components connected to the network 1030 (whether illustrated or not). For example, database 1006 can be an in-memory, conventional, or a database storing data consistent with the present disclosure. In some implementations, database 1006 can be a combination of two or more different database types (for example, hybrid in-memory and conventional databases) according to particular needs, desires, or particular implementations of the computer 1002 and the described functionality. Although illustrated as a single database 1006 in FIG. 9, two or more databases (of the same, different, or combination of types) can be used according to particular needs, desires, or particular implementations of the computer 1002 and the described functionality. While database 1006 is illustrated as an internal component of the computer 1002, in alternative implementations, database 1006 can be external to the computer 1002.

The computer 1002 also includes a memory 1007 that can hold data for the computer 1002 or a combination of components connected to the network 1030 (whether illustrated or not). Memory 1007 can store any data consistent with the present disclosure. In some implementations, memory 1007 can be a combination of two or more different types of memory (for example, a combination of semiconductor and magnetic storage) according to particular needs, desires, or particular implementations of the computer 1002 and the described functionality. Although illustrated as a single memory 1007 in FIG. 9, two or more memories 1007 (of the same, different, or combination of types) can be used according to particular needs, desires, or particular implementations of the computer 1002 and the described functionality. While memory 1007 is illustrated as an internal component of the computer 1002, in alternative implementations, memory 1007 can be external to the computer 1002.

The application 1008 can be an algorithmic software engine providing functionality according to particular needs, desires, or particular implementations of the computer 1002 and the described functionality. For example, application 1008 can serve as one or more components, modules, or applications. Further, although illustrated as a single application 1008, the application 1008 can be implemented as multiple applications 1008 on the computer 1002. In addition, although illustrated as internal to the computer 1002, in alternative implementations, the application 1008 can be external to the computer 1002.

The computer 1002 can also include a power supply 1014. The power supply 1014 can include a rechargeable or non-rechargeable battery that can be configured to be either user- or non-user-replaceable. In some implementations, the power supply 1014 can include power-conversion and management circuits, including recharging, standby, and power management functionalities. In some implementations, the power-supply 1014 can include a power plug to allow the computer 1002 to be plugged into a wall socket or a power source to, for example, power the computer 1002 or recharge a rechargeable battery.

There can be any number of computers 1002 associated with, or external to, a computer system containing computer 1002, with each computer 1002 communicating over network 1030. Further, the terms “client,” “user,” and other appropriate terminology can be used interchangeably, as appropriate, without departing from the scope of the present disclosure. Moreover, the present disclosure contemplates that many users can use one computer 1002 and one user can use multiple computers 1002.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of embodiments of these systems and methods have been described. Nevertheless, it will be understood that various modifications may be made without departing from the spirit and scope of this disclosure. Accordingly, other embodiments are within the scope of the following claims.

### Examples

In an example implementations, a method for predicting reservoir properties in a subsurface formation includes accessing, from a data store, seismic inversion data and well log data for the subsurface formation; generating a training dataset including data extracted from the seismic inversion data based on locations of wells in the subsurface formation and the well log data from the wells, the training dataset including, for a set of wells in the subsurface, seismic inversion data with corresponding labeled data representing total porosity values and electro-facies values; training a neural network based on the training dataset; and predicting porosity values for the reservoir based on the seismic inversion data and the trained neural network.

An aspect combinable with the example implementation includes determining one or more locations in the subsurface formation to drill new wells based on the predicted reservoir porosity values; and controlling drilling equipment to drill wells at the determined one or more locations based on the predicted porosity values.

In another aspect combinable with any of the previous aspects, the seismic inversion data includes absolute and bandpass seismic inversion data.

In another aspect combinable with any of the previous aspects, the neural network includes a one dimensional convolutional neural network with a recurrent layer.

Another aspect combinable with any of the previous aspects includes removing missing values from the training dataset; normalizing the training dataset; and zero-padding the training dataset based on a specified sample length.

In another aspect combinable with any of the previous aspects, training the neural network includes determining a mean-squared error between the labeled data and data generated by the neural network; and tuning hyperparameters of the neural network based on the determined mean-squared error.

In another aspect combinable with any of the previous aspects, the seismic inversion data includes three-dimensional volumes of seismic inversion data; and predicting porosity values includes providing the three-dimensional volumes of seismic inversion data as input to the trained neural network.

In another aspect combinable with any of the previous aspects, the predicted porosity values include a three-dimensional distribution of porosity.

Another aspect combinable with any of the previous aspects includes predicting a three-dimensional distribution of electro-facies for the reservoir based on the trained neural network and the three-dimensional volumes of seismic inversion data.

In another example implementation, a system for predicting reservoir properties in a subsurface formation includes at least one processor and a memory storing instructions that when executed by the at least one processor cause the at least one processor to perform operations including accessing, from a data store, seismic inversion data and well log data for the subsurface formation; generating a training dataset including data extracted from the seismic inversion data based on locations of wells in the subsurface formation and the well log data from the wells, the training dataset including, for a set of wells in the subsurface, seismic inversion data with corresponding labeled data representing total porosity values and electro-facies values; training a neural network based on the training dataset; and predicting porosity values for the reservoir based on the seismic inversion data and the trained neural network.

In an aspect combinable with the example implementation, the operations further include determining one or more locations in the subsurface formation to drill new wells based on the predicted reservoir porosity values; and controlling drilling equipment to drill wells at the determined one or more locations based on the predicted porosity values.

In another aspect combinable with any of the previous aspects, the seismic inversion data includes absolute and bandpass seismic inversion data.

In another aspect combinable with any of the previous aspects, the neural network includes a one dimensional convolutional neural network with a recurrent layer.

In another aspect combinable with any of the previous aspects, the operations further include removing missing values from the training dataset;
normalizing the training dataset; and zero-padding the training dataset based on a specified sample length.

In another aspect combinable with any of the previous aspects, training the neural network includes determining a mean-squared error between the labeled data and data generated by the neural network; and tuning hyperparameters of the neural network based on the determined mean-squared error.

In another aspect combinable with any of the previous aspects, the seismic inversion data includes three-dimensional volumes of seismic inversion data; and predicting porosity values includes providing the three-dimensional volumes of seismic inversion data as input to the trained neural network.

In another example implementation, one or more non-transitory, machine-readable storage devices storing instructions for predicting reservoir properties in a subsurface formation, the instructions being executable by one or more processors, to cause performance of operations including accessing, from a data store, seismic inversion data and well log data for the subsurface formation; generating a training dataset including data extracted from the seismic inversion data based on locations of wells in the subsurface formation and the well log data from the wells, the training dataset including, for a set of wells in the subsurface, seismic inversion data with corresponding labeled data representing total porosity values and electro-facies values; training a neural network based on the training dataset; and predicting porosity values for the reservoir based on the seismic inversion data and the trained neural network.

In another aspect combinable with any of the previous aspects, the operations further include determining one or more locations in the subsurface formation to drill new wells based on the predicted reservoir porosity values; and controlling drilling equipment to drill wells at the determined one or more locations based on the predicted porosity values.

In another aspect combinable with any of the previous aspects, the operations further include removing missing values from the training dataset; normalizing the training dataset; and zero-padding the training dataset based on a specified sample length.

In another aspect combinable with any of the previous aspects, training the neural network includes determining a mean-squared error between the labeled data and data generated by the neural network; and tuning hyperparameters of the neural network based on the determined mean-squared error.

What is claimed is:

1. A method for predicting reservoir properties in a subsurface formation, the method comprising:
accessing, from a data store, seismic inversion data and well log data for the subsurface formation;
generating a training dataset comprising data extracted from the seismic inversion data based on locations of wells in the subsurface formation and the well log data from the wells, the training dataset including, for a set of wells in the subsurface, seismic inversion data with corresponding labeled data representing total porosity values and electro-facies values;
training a neural network based on the training dataset; and
predicting porosity values for the reservoir based on the seismic inversion data and the trained neural network.

2. The method of claim 1, further comprising:
determining one or more locations in the subsurface formation to drill new wells based on the predicted reservoir porosity values; and
controlling drilling equipment to drill wells at the determined one or more locations based on the predicted porosity values.

3. The method of claim 1, wherein the seismic inversion data comprises absolute and bandpass seismic inversion data.

4. The method of claim 1, wherein the neural network comprises a one dimensional convolutional neural network with a recurrent layer.

5. The method of claim 1, further comprising:
removing missing values from the training dataset;
normalizing the training dataset; and
zero-padding the training dataset based on a specified sample length.

6. The method of claim 1, wherein training the neural network comprises:
determining a mean-squared error between the labeled data and data generated by the neural network; and
tuning hyperparameters of the neural network based on the determined mean-squared error.

7. The method of claim 1, wherein the seismic inversion data comprises three-dimensional volumes of seismic inversion data; and
wherein predicting porosity values comprises providing the three-dimensional volumes of seismic inversion data as input to the trained neural network.

8. The method of claim 7, wherein the predicted porosity values comprise a three-dimensional distribution of porosity.

9. The method of claim 8, further comprising:
predicting a three-dimensional distribution of electro-facies for the reservoir based on the trained neural network and the three-dimensional volumes of seismic inversion data.

10. A system for predicting reservoir properties in a subsurface formation, the system comprising:
at least one processor and a memory storing instructions that when executed by the at least one processor cause the at least one processor to perform operations comprising:
accessing, from a data store, seismic inversion data and well log data for the subsurface formation;
generating a training dataset comprising data extracted from the seismic inversion data based on locations of wells in the subsurface formation and the well log data from the wells, the training dataset including, for a set of wells in the subsurface, seismic inversion data with corresponding labeled data representing total porosity values and electro-facies values;
training a neural network based on the training dataset; and
predicting porosity values for the reservoir based on the seismic inversion data and the trained neural network.

11. The system of claim 10, wherein the operations further comprise:
determining one or more locations in the subsurface formation to drill new wells based on the predicted reservoir porosity values; and
controlling drilling equipment to drill wells at the determined one or more locations based on the predicted porosity values.

12. The system of claim 10, wherein the seismic inversion data comprises absolute and bandpass seismic inversion data.

13. The system of claim 10, wherein the neural network comprises a one dimensional convolutional neural network with a recurrent layer.

14. The system of claim 10, wherein the operations further comprise:
removing missing values from the training dataset;
normalizing the training dataset; and
zero-padding the training dataset based on a specified sample length.

15. The system of claim 10, wherein training the neural network comprises:
determining a mean-squared error between the labeled data and data generated by the neural network; and
tuning hyperparameters of the neural network based on the determined mean-squared error.

16. The system of claim 10, wherein the seismic inversion data comprises three-dimensional volumes of seismic inversion data; and
wherein predicting porosity values comprises providing the three-dimensional volumes of seismic inversion data as input to the trained neural network.

17. One or more non-transitory, machine-readable storage devices storing instructions for predicting reservoir properties in a subsurface formation, the instructions being executable by one or more processors, to cause performance of operations comprising:
accessing, from a data store, seismic inversion data and well log data for the subsurface formation;
generating a training dataset comprising data extracted from the seismic inversion data based on locations of wells in the subsurface formation and the well log data from the wells, the training dataset including, for a set of wells in the subsurface, seismic inversion data with corresponding labeled data representing total porosity values and electro-facies values;
training a neural network based on the training dataset; and
predicting porosity values for the reservoir based on the seismic inversion data and the trained neural network.

18. The non-transitory, machine-readable storage devices of claim 17, wherein the operations further comprise:
determining one or more locations in the subsurface formation to drill new wells based on the predicted reservoir porosity values; and
controlling drilling equipment to drill wells at the determined one or more locations based on the predicted porosity values.

19. The non-transitory, machine-readable storage devices of claim 17, wherein the operations further comprise:
removing missing values from the training dataset;
normalizing the training dataset; and
zero-padding the training dataset based on a specified sample length.

20. The non-transitory, machine-readable storage devices of claim 17, wherein training the neural network comprises:
determining a mean-squared error between the labeled data and data generated by the neural network; and
tuning hyperparameters of the neural network based on the determined mean-squared error.
